(19) United States
(12) Patent Application Publication
(10) Pub. No.: US 2022/0111566 A1
(43) Pub. Date: Apr. 14, 2022

(54) System and Method for Achieving a One Component Growable Resin System

(71) Applicants: Robert Michael Davies, Texarkana, TX (US); Williamson Sy, Oak Park, MI (US)

(72) Inventors: Robert Michael Davies, Texarkana, TX (US); Williamson Sy, Oak Park, MI (US)

(21) Appl. No.: 17/556,217

(22) Filed: Dec. 20, 2021

Related U.S. Application Data
(63) Continuation-in-part of application No. PCT/IB2020/055758, filed on Jun. 18, 2020.
(60) Provisional application No. 62/863,071, filed on Jun. 18, 2019.

(51) Int. Cl. B29C 33/56; C08G 59/24

(52) U.S. Cl. CPC B29C 33/56; B29K 2063/00; C08G 59/24

(57) ABSTRACT

A system and method for achieving a one component growable resin system includes a quantity of growable resin and a quantity of growth initiator. The quantity of growable resin is in a final solid state, and the quantity of growth initiator is in an inactive form. A usable initiator portion, that includes a plurality of resin molecules and is from the quantity of growth initiator, contacts a usable resin portion, from the quantity of growable resin. Being in an inactive form, the usable initiator portion is unable to cause resin growth by being physically inactive or by being physically separate from the usable resin portion. The usable initiator portion is activated to initiate a chemical reaction amongst the plurality of molecules. The chemical reaction results with growth in the usable resin portion by increasing the molecular weight of the usable resin portion.

The current application is a continuation-in-part (CIP) application of the Patent Cooperation Treaty (PCT) application PCT/IB2020/055758 filed on Jun. 18, 2020. The PCT application PCT/IB2020/055758 claims a priority to a U.S. Provisional Patent application Ser. No. 62/863,071 filed on Jun. 18, 2019.

### FIELD OF THE INVENTION

The present invention relates generally to a field of chemistry: natural resins or derivatives. More specifically, the present invention is a method for achieving a one component growable resin system.

### BACKGROUND OF THE INVENTION

Short molecular chain resins generally have certain advantages over long molecular chain resins. For example, lower viscosity, better wetting ability of substrate in case of adhesive applications and other processing advantages. However, the short molecular chain resins also generally have some disadvantages. For example, poorer mechanical properties, less heat resistance, etc.

To overcome such disadvantages, the concept of growing the resin after it has been formed into a shape of the final product is sometimes applied.

In growable resins, the issue of how to prevent resin growth before it is formed into the shape of the final product is a key factor to its practicality(i.e., excessive premature resin growth, e.g., during storage, would render the resin unusable for its original intended purpose). For example, viscosity would be too high or molecular chain would be too long to achieve sufficient adhesion or conforming to the desired shape in a mold.

Therefore, there is a need for improved materials and processes to achieve a one component growable resin system that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

According to some embodiments, one component growable resin system is disclosed. Accordingly, one component means that no significant mixing of components is required prior to use. In an instance, it may mean that a system may be already pre-mixed under normal storage conditions. In another instance, it may mean 2 components that are brought in contact with each other immediately prior to use or during use but no significant mixing of the 2 components is required. Further, materials and processes to achieve the one component growable resin system may include a growable resin that may be stable under normal storage conditions. Further, the growable resin may grow when exposed to special growth initiation conditions. Further, the special growth initiation condition may be a presence of growth initiators. Further, the growth initiators need not be homogeneously dispersed throughout the resin (i.e., once growth starts in one area in the resin, the growth may propagate to a significant distance away from starting point). Further, in some embodiment, the growth initiator may be already in an active form but brought into contact with the growable resin only after the growable resin may become solid. Further, in another embodiment, the growth initiator may be brought into contact with the growable resin while the growth initiator may be in an inactive form. Further, the growth initiator may be transformed into the active form when the resin may be desired to commence growing. Further, the active form may usually be achieved by exposing the growth initiator to special growth initiation conditions.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

FIG. 1 is a flowchart illustrating the overall process of the present invention.

FIG. 2 is a schematic diagram displaying one application for the present invention.

FIG. 3 is a schematic diagram displaying another application for the present invention.

FIG. 4 is a schematic diagram displaying a molding application for the present invention.

FIG. 5 is a schematic diagram displaying a towpreg application for the present invention.

### DETAIL DESCRIPTIONS OF THE INVENTION

All illustrations of the drawings are for the purpose of describing selected versions of the present invention and are not intended to limit the scope of the present invention.

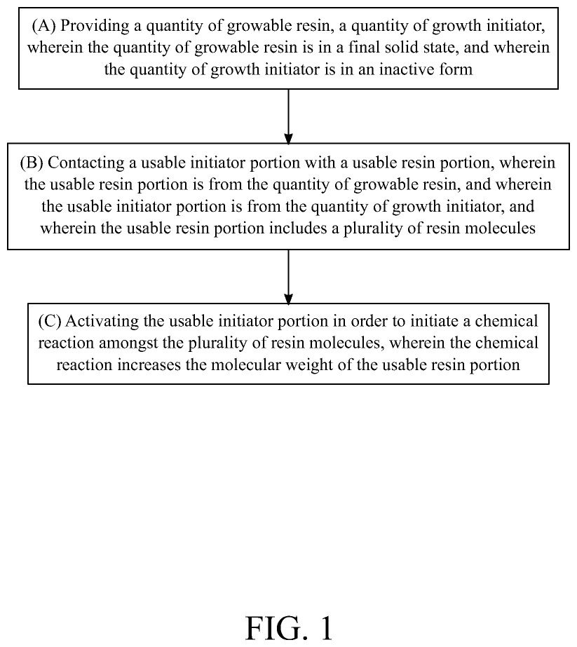

The present invention is a system and method for achieving a one component growable resin system. In further detail, the present invention is a process for resin growth where all substances are pre-mixed under normal storage conditions instead of requiring mixing during application or requiring pre-mixing before application. In reference to FIG. 1, the present invention includes a quantity of growable resin, and a quantity of growth initiator (Step A). The quantity of growable resin is in a solid state, and the quantity of growth initiator is in an inactive form. The quantity of growable resin must be stable under normal storage conditions. Normal storage conditions include temperatures at approximately 40 degrees Celsius, more than 80% relative humidity, and limited exposure to light. Thus, the quantity of growable resin may compositionally include a cycloaliphatic/heterocyclic epoxy. This composition provides growth points for the quantity of growable resin. Further, cycloaliphatic/heterocyclic epoxy groups are very stable under high temperatures, approximately up to 200 degrees Celsius, in non-acidic environments including, but not limited to, alkaline. This allows an easy path for the incorporating growth points into the quantity of growable resin. The cycloaliphatic/heterocyclic epoxy can preferably be 4-vinylcylohexene dioxide because 4-vinylcylohexene dioxide contains 1 cycloaliphatic/heterocyclic epoxy group and 1 non-cycloaliphatic/heterocyclic epoxy group. The non-cycloaliphatic/heterocyclic epoxy group can be reacted with a carboxylic group in order to produce an OH group at a grafting site. A grafting site is where a chemical reaction occurs, wherein a molecule is attached to another, usually bigger, molecule. The grafting occurs readily under alkaline conditions. The cycloaliphatic/heterocyclic epoxy group remains unreactive under alkaline conditions, especially at temperatures under 200 degrees Celsius. The quantity of growable resin is selected from the group consisting of: bisphenol A epoxy resin, urethane resin, acrylic resin, polymethacrylate resin, polyolefin resin, and combinations thereof. The quantity of growable resin being one of the aforementioned type of resins allows for synthetization under non-acidic conditions. The quantity of growth initiator being in an inactive form means the quantity of growth initiator is unable to cause resin growth. For example, the quantity of growth initiator is physically inactive or is physically separate from the quantity of growable resin. The quantity of growth initiator is preferably a strong acid which requires a condition such as, but not limited to, high heat or ultraviolet light (UV) radiation in order to be activated.

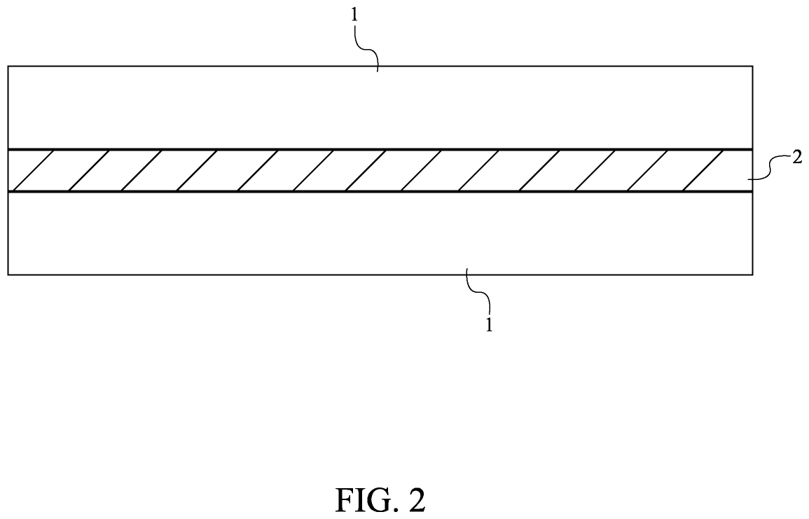

The method of the present invention follows an overall process which achieves resin growth using a one component system. With reference to FIGS. 1 and 2, a usable initiator portion 2 contacts a usable resin portion 1 (Step B). The usable resin portion 1 is from the quantity of growable resin while the usable initiator portion 2 is from the quantity of the growth initiator. Further, the usable resin portion 1 includes a plurality of resin molecules. The usable initiator portion 2 can come in contact with the usable resin portion 1 through various methods. More specifically, the usable initiator portion is added to the surface of the bulk of the usable resin portion 1 and not mixed into the bulk of the usable resin portion 1. By using the appropriate growth initiator and growable resin combination, resin growth can propagate a significant distance away from the usable initiator portion 2. The usable initiator portion 2 is activated in order to initiate a chemical reaction amongst the plurality of resin molecules (Step C). In more detail, the chemical reaction causes the plurality of molecules to attach to each other. The chemical reaction results with growth in the usable resin portion 1 by increasing the molecular weight of the usable resin portion 1. The usable initiator portion 2 can be activated through various methods. Once growth starts in one area of the usable resin portion 1, the growth may propagate to a significant distance, even more than 1 millimeter up to 5 millimeters, from the location of the usable initiator portion 2.

Alternatively, Step B or C can be optional based on the situation. For example, if the quantity of initiator is in inactive form, the usable initiator portion 2 can be already premixed. The quantity of initiator can also be in active form from the beginning and brought into contact with usable resin portion 1 only just before reaction. In more detail, the usable initiator portion 2 can be premixed into a carrier film and coated onto growable resin tows. Thus, coated resin tows can be placed in a mold, and the heat and pressure in the mold causes the particles of the usable initiator portion 2 to come into closer contact with the usable resin portion 1 and start resin growth. No significant resin growth occurs before that, even if the quantity of initiator is already active, because contact of the usable initiator portion 2 with the usable resin portion 1 is minimal. In more detail, solid powder particles of the usable initiator portion 2 can be lightly touching the bulk surface of the usable resin portion 1.

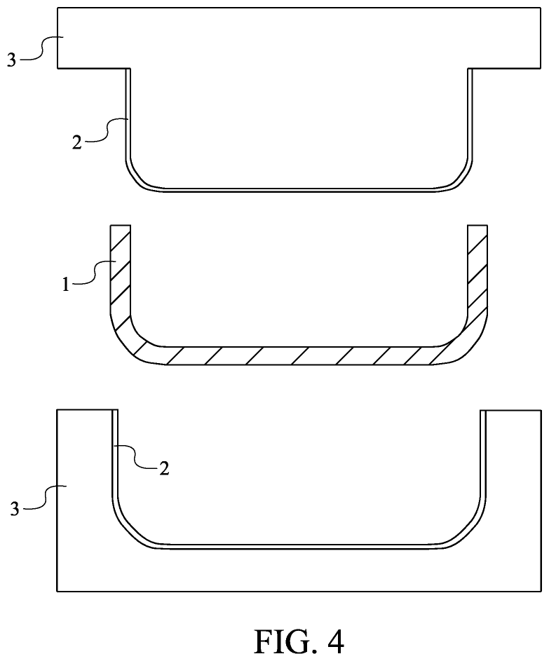

The present invention can be used for molding applications. For molding applications and with reference to FIG. 4, the present invention includes a mold assembly 3 with a first engagement surface and a second engagement surface. The first engagement surface and the second engagement surface are offset from each other. The first engagement surface is coated with the usable initiator portion 2, and the second engagement surface is coated with the usable initiator portion 2. The usable resin portion 1 is positioned within the mold assembly 3. More specifically in this case, the usable resin portion 1 is positioned between the first engagement surface and the second engagement surface in order for the usable initiator portion 2 to come in contact with the usable resin portion 1. Further, the usable resin portion 1 is preferably a thermoset resin. The usable resin portion 1 can be in a near net shape preform that is placed in between the first engagement surface and the second engagement surface. Alternatively, the usable resin portion 1 can be injected into a closed mold assembly 3. Furthermore, resin growth can occur during the molding process and/or after the molding process.

Alternatively, the usable resin portion 1 can be coated with the usable initiator portion 2 rather than coating the mold assembly 3 with the usable initiator portion 2. In this case, the usable initiator portion 2 comes into contact with the usable resin portion 1 after resin processing and before the usable resin portion 1 is positioned within the mold assembly 3.

In another embodiment, the usable initiator portion 2 contacts the usable resin portion 1 during resin processing. In further detail, the quantity of growth initiator is processed into the quantity of growable resin. In this case, the quantity of growable resin and the quantity of growth initiator must be heat stable in order for the quantity of growable resin to be stable enough to withstand the processing conditions. Thus, the usable initiator portion 2 in this embodiment is integrated into the usable resin portion 1 and can be readily activated after positioning the usable resin portion 1.

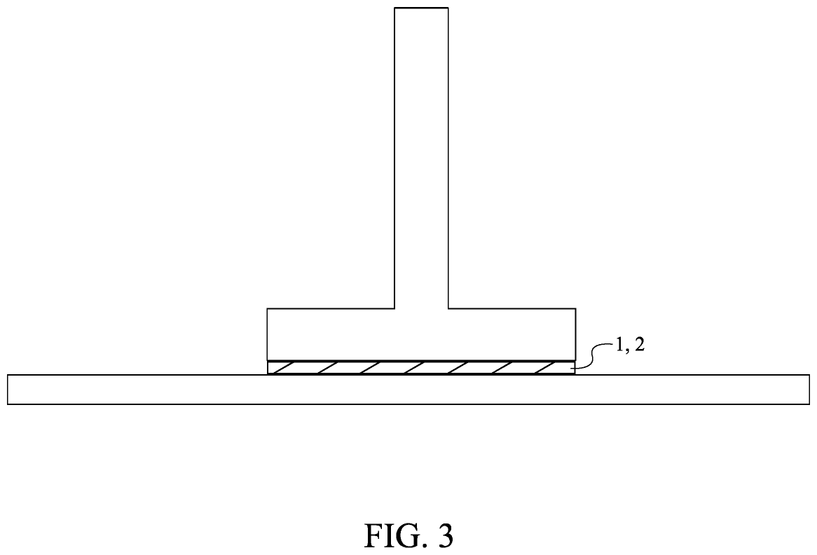

In another embodiment of the present invention and with reference to FIGS. 2 and 3, the usable resin portion 1 can be in form of a growable resin sheet and the usable initiator portion 2 can be solvent cast into a carrier film. The usable initiator portion 2 contacts the usable resin portion 1 by being positioned in between two growable resin sheets. The usable initiator portion 2 is an adhesive carrier film to maximize the bond line between the usable resin portion 1. The usable resin portion 1 is preferably made from Epiklon 1010, and the usable initiator portion 2 can be made of K-PURE CXC-1612 latent acid.

As mentioned previously, the usable resin portion 1 is activated through various methods. Step C may be executed by applying heat to the usable initiator portion 2. In this case, the usable initiator portion 2 can be, but is not limited to, K-PURE CXC-1612 or NaCure XP-357 heat-activated latent acids. The heat is enough to cause the usable initiator portion 2 to activate and not too high allowing the usable resin portion 1 to remain stable.

Alternatively, Step C may be executed by applying electromagnetic energy to the usable initiator portion 2. Electromagnetic energy can be applied via ultraviolet light or electron beam. In this case, the usable initiator portion 2 is preferably a cationic UV initiator. This would best be applied to the case where the quantity of growth initiator is processed into the quantity of growth initiator.

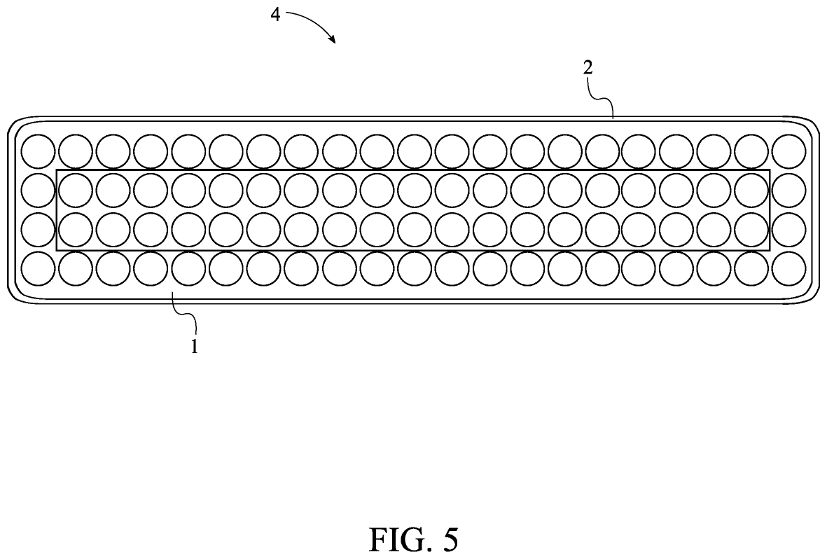

In another embodiment and with reference to FIG. 5, the present invention can be used to make a composite towpreg 4 like those described in Flexible Composite Prepreg Materials U.S. Pat. No. 7,790,284. Applying the usable resin portion 1 to a fiber tow as practiced in the patent with an additional secondary step of applying the usable initiator portion 2 to the tow surface. One way to apply the usable initiator portion 2 is to put the usable initiator portion 2 in a solution and dipping the towpreg 4 into said solution followed by a drying process. The solution containing the usable initiator portion 2 can also contain a binder resin that is compatible with usable resin portion 1.

In another embodiment, a sheet molding compound can be prepared using multiple layers of the usable resin portion 1 in sheet form. Sheet mold methods generally use resin and chopped fiber sheets cut to a size smaller than the mold. The precut sheets are built into a charge that contains enough material to fill the mold. The mold closure compresses the compound forcing it to fill the cavity. Heat from the mold would create the special condition to initiate growth. The preforms in both cases could have reinforcements such as carbon fiber or glass fiber to further increase the mechanical properties. The preforms could also be made from a composite towpreg 4.

One potential advantage of such resins compared to growable resins like polyamide-imide (PAI) is that the growth reaction does not occur for such resins until the resin enters the mold, whereas PAI resins already start their growth reaction in the extruder used to inject it into the mold, thereby limiting the amount of time the resin can stay in the extruder without significantly impacting molding conditions. Furthermore, because the growth reaction for such resins commence at and occur very quickly (sometimes even already finished by the time the product is removed from the mold), the tendency for product dimensional distortion during the secondary growth process after it is removed from the mold is minimized versus in case of PAI resins.

Although the invention has been explained in relation to its preferred embodiment, it is to be understood that many other possible modifications and variations can be made without departing from the spirit and scope of the invention as hereinafter claimed.

What is claimed is:

1. A method for achieving a one component growable resin system, the method comprising the steps of:
(A) providing a quantity of growable resin, a quantity of growth initiator, wherein the quantity of growable resin is in a solid state, and wherein the quantity of growth initiator is in an inactive form;
(B) contacting a usable initiator portion with a usable resin portion, wherein the usable resin portion is from the quantity of growable resin, and wherein the usable initiator portion is from the quantity of growth initiator, and wherein the usable resin portion includes a plurality of resin molecules; and
(C) activating the usable initiator portion in order to initiate a chemical reaction amongst the plurality of resin molecules, wherein the chemical reaction increases the molecular weight of the usable resin portion.

2. The method as claimed in claim 1 comprising the steps of:
providing a mold assembly with a first engagement surface and a second engagement surface, wherein the first engagement surface and the second engagement surface are offset from each other;
coating the first engagement surface with the usable initiator portion;
coating the second engagement surface with the usable initiator portion; and
positioning the usable resin portion within the mold assembly.

3. The method as claimed in claim 1 comprising the step of:
coating the usable resin portion with the usable initiator portion.

4. The method as claimed in claim 1 comprising the step of:
processing the quantity of growth initiator into the quantity of growable resin.

5. The method as claimed in claim 1 comprising the step of:
executing step (C) by applying heat to the usable initiator portion.

6. The method as claimed in claim 1 comprising the step of:
executing step (C) by applying electromagnetic energy to the usable initiator portion.

7. The method as claimed in claim 1, wherein the quantity of growable resin compositionally includes a cycloaliphatic/heterocyclic epoxy.

8. The method as claimed in claim 7, wherein the cycloaliphatic/heterocyclic epoxy is 4-vinylcyclohexene dioxide.

9. The method as claimed in claim 1, wherein the quantity of growable resin is selected from the group consisting of: bisphenol A epoxy resin, urethane resin, acrylic resin, polymethacrylate resin, polyolefin resin, and combinations thereof.
